(19) United States
(12) Patent Application Publication
(10) Pub. No.: US 2013/0216798 A1
(43) Pub. Date: Aug. 22, 2013

(54) COATED ARTICLE AND PROCESS OF COATING AN ARTICLE

(71) Applicants: Warren Arthur NELSON, Clifton Park, NY (US); Yuk-Chiu LAU, Ballston Lake, NY (US); Paul Stephen DiMASCIO, Greer, SC (US)

(72) Inventors: Warren Arthur NELSON, Clifton Park, NY (US); Yuk-Chiu LAU, Ballston Lake, NY (US); Paul Stephen DiMASCIO, Greer, SC (US)

(73) Assignee: GENERAL ELECTRIC COMPANY, Schenectady, NY (US)

(21) Appl. No.: 13/399,308

(22) Filed: Feb. 17, 2012

(51) Int. Cl. B32B 7/02; B32B 3/00; B32B 15/04

(52) U.S. Cl. 428/212; 428/457; 428/332; 427/405

(57) ABSTRACT

A coated article and a coating application process are disclosed. The coated article includes a metallic surface, a first layer positioned proximal to the metallic surface, the first layer having a first ductility, and a second layer positioned distal from the metallic surface, the second layer having a second ductility. The first ductility is at least about 20% greater than the second ductility. The process includes providing an article, the article comprising a metallic surface, applying a first layer proximal to the metallic surface, the first layer having a first ductility, and applying a second layer distal from the metallic surface, the second layer having a second ductility.

### FIELD OF THE INVENTION

The present invention is directed to coated articles and process of coating. More specifically, the present invention is directed to coated articles and processes of coating metal and metallic components to improve fatigue resistance.

### BACKGROUND OF THE INVENTION

Metal components are used in a wide variety of industrial applications, under a diverse set of operating conditions. In many cases, the components are provided with coatings that impart desirable characteristics to improve operability of the components. As one example, the various components of turbine engines are often coated with thermal barrier coatings, to effectively increase the temperature at which they can operate. A second example is the use of oxidation or corrosion resistant coatings on turbine components. Hard coatings to resist erosion or wear are also used on certain components within turbine engines. Other examples of articles which require some sort of protective coating include pistons used in internal combustion engines and other types of machines.

Thermal spray is often used for applying functional coatings onto components to improve their performance. Coatings may be used to impart desirable characteristics to the components such as improved oxidation or corrosion resistance, improved temperature capability, improved wear or erosion resistance, abradability, and/or dimensional build-up. Common techniques of thermal spray are cold spray, High Velocity Oxy Fuel (HVOF), air plasma spray, vacuum plasma spray, electric arc spray, and flame spray. The surface of the components can be grit blasted to prepare it for coating. Grit blasting roughens the substrate surface to promote adherence of the coating and may also serve as a cleaning method. In some instances grit blasting can impart a compressive stress at the surface of the component and hence improve fatigue resistance. While the coatings are applied to articles in order to improve some characteristic of the article, the coating itself may cause a negative effect on a different characteristic. An example of this would be application of a hard coating onto an article to improve wear resistance. However, such a wear coating is generally formed from hard particles and the deposited coating has low ductility and is brittle. The hardness and reduced ductility of such a coating can decrease the fatigue life of the coated article because a crack can form at the surface of the coating and propagate through the brittle coating and into the metallic substrate. Fatigue debit is most noted with hard, brittle coatings whereas soft, ductile coatings do not cause a debit and in many cases can improve fatigue life.

A coated article and a coating application process not suffering from one or more of the above drawbacks would be desirable in the art.

### BRIEF DESCRIPTION OF THE INVENTION

In an exemplary embodiment, a coated article includes a metallic surface, a first layer positioned proximal to the metallic surface, the first layer having a first ductility, and a second layer positioned distal from the metallic surface, the second layer having a second ductility. The first ductility is at least about 20% greater than the second ductility.

In another exemplary embodiment, a coated article includes a metallic surface, an interlayer positioned on the metallic surface, the interlayer having a first ductility, and an outer layer positioned on the interlayer, the outer layer having a second ductility. The first ductility is at least about 20% greater than the second ductility.

In another exemplary embodiment, a coating application process includes providing an article, the article comprising a metallic surface, applying a first layer proximal to the metallic surface, the first layer having a first ductility, and applying a second layer distal from the metallic surface, the second layer having a second ductility. The first ductility is at least about 20% greater than the second ductility.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a perspective view of an exemplary coated article according to the disclosure.

FIG. 2 is a schematic view showing a plurality of layers in a coating on an exemplary coated article according to the disclosure.

Wherever possible, the same reference numbers will be used throughout the drawings to represent the same parts.

### DETAILED DESCRIPTION OF THE INVENTION

Provided is a coated article and a coating application process not suffering from one or more of the above drawbacks. Embodiments of the present disclosure permit extended use of articles due to delayed repair or replacement resulting from decreased fatigue life, slows crack propagation of hard and/or brittle outer coatings by including an interlayer, and combinations thereof.

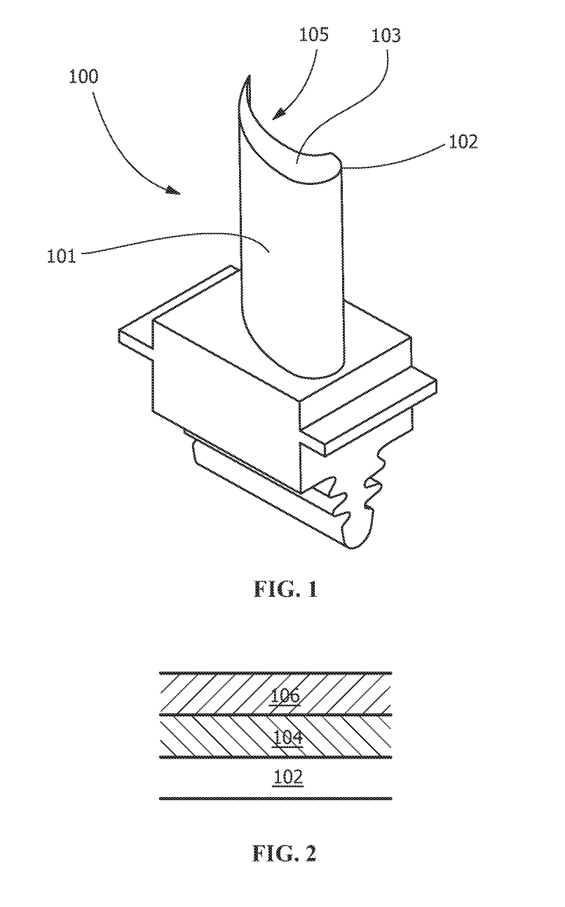

FIG. 1 shows a coated article 100 according to an embodiment of the disclosure. The coated article 100 is a compressor component, a turbine component, or other suitable metallic component commonly subjected to fatigue-type forces, such as low cycle fatigue. As used herein, the term “metallic” is intended to encompass metals, metallic alloys, composite metals, or any other suitable material including metal elements susceptible to fatigue-type forces.

The article 100 is formed of a suitable substrate 101. In one embodiment, the substrate 101 has a compositional range of, by weight, between about 14.0% and about 16.0% Cr, between about 6.0% and about 7.0% Ni, between about 1.25% and about 1.75% Cu, between about 0.5% and about 1.0% Mo, between about 0.025% and about 0.050% C, between about 0.20% and about 0.75% Nb, a maximum of about 1.0% Mn, a maximum of about 1.0% Si, a maximum of about 0.10% V, a maximum of about 0.10% Sn, a maximum of about 0.030% N, a maximum of about 0.025% P, a maximum of about 0.05% S, a maximum of about 0.005% Al, a maximum of about 0.005% Ag, a maximum of about 0.005% Pb, a balance of Fe, and inevitable impurities.

The article 100 includes a metallic surface 102. The metallic surface 102 is a wear surface, a rotating surface, a sliding surface, another surface subject to fatigue-type forces, or a combination thereof. The metallic surface 102 has a coating 103 positioned on it. In one embodiment, the metallic surface 102 is positioned on a compressor blade tip 105 as is shown in FIG. 1. In another embodiment, the metallic surface 102 is a wear pad, such as, a mid-span damper on a turbine bucket or a Z-notch on a bucket tip.

As shown in FIG. 2, the coating 103 includes a plurality of layers. In one embodiment, a first layer 104, such as an interlayer or a metallic interlayer, is positioned on the metallic surface 102, proximal to the metallic surface 102, enclosed from the environment, or combinations thereof. In a further embodiment, a second layer 106, such as an outer layer or wear layer, is positioned distal from the metallic surface 102, on the first layer 104, exposed to the environment, or combinations thereof.

The ductility, or strain-to-crack capability, of the coating forming the first layer 104 is a predetermined percent greater than the ductility, or strain-to-crack capability, of the coating forming the second layer 106. For example, in one embodiment, the first layer 104 has a strain-to-crack value of greater than at least 1.0% and the second layer 106 has a strain-to-crack capability of 0.5%, thereby resulting in the ductility of the first layer 104 being 100% greater than the ductility of the second layer 106. In other embodiments, the predetermined percent is at least about 20%, at least about 30%, at least about 50%, at least about 70%, at least about 100%, at least about 200%, at least 1000%, between about 200% and about 1000%, between about 20% and about 200%, between about 20% and about 100%, between about 30% and about 100%, between about 50% and about 100%, between about 50%, and about 70%, at about 50%, at about 70%, at about 100%, or any suitable combination, subcombination, range, or sub-range within. The ductile characteristics of the first layer 104 permits harder and more brittle materials to be used in the second layer 106 than would otherwise be able to be used without causing crack propagation into the metallic surface 102 that can cause further damage in regions receiving fatigue-type forces. The coating forming the first layer 104 has a first ductility that is greater than the ductility of the second layer 106.

The coating forming the second layer 106 has a second ductility. The second ductility is less than the first ductility. For example, in one embodiment, the coating forming the second layer 106 includes a composition of WCCoCr, WC₁₀Co₄Cr, Cr₃C₂, Cr₃C₂ 7(Ni₂₀Cr), or a combination thereof and/or having a strain-to-crack value of about 0.3%. The first layer 104 and the second layer 106 are any suitable alloys. In one embodiment, the first layer 104 is a metallic layer (for example, including a composition of CoNiCrAlY and/or having a strain-to-crack value of about 4%). In a further embodiment, the first layer 104 is an aluminum-based alloy, such as, a sprayable alloy, for example, having a composition, by weight, of about 99% Al, or a composition having, by weight, between about 3.9% and about 5.0% Cu, between about 0.50% and about 0.9% Si, up to about 0.5% Fe, between about 0.4% and about 1.2% Mn, up to about 0.10% Cr, between about 0.2% and about 0.8% Mg, up to about 0.1% Ni, up to about 0.25% Zn, up to about 0.20% Ti+Zr, up to about 0.15% Ti, incidental impurities, and a balance Al.

In one embodiment, the metallic surface 102 includes an alloy having a compositional range of, by weight, up to about 0.08% C, up to about 0.35% Mn, up to about 0.35% Si, up to about 0.015% P, up to about 0.015% S, between about 50% and about 55% Ni, between about 17% and about 21% Cr, up to about 1.0% Co, between about 0.35% and about 0.80% Al, between about 2.8% and about 3.3% Mo, between about 0.65% and about 1.2% Ti, between about 0.001% and about 0.006%, up to about 0.15% Cu, between about 4.75% and about 5.5% Nb with Ta, a balance Fe, and inevitable impurities. Generally, the second layer 106 is any suitable material that is harder than the first layer 104. In one embodiment, the second layer 106 is or includes a ceramic or other non-metallic material. In one embodiment, the second layer 106 includes one or more of tungsten carbide, boron carbide, chrome carbide, and cobalt.

The first layer 104 and the second layer 106 have any suitable thicknesses. In one embodiment, the first layer 104 has a first thickness 108, for example, between about 3 mils and about 10 mils, between about 5 mils and about 10 mils, or about 5 mils. In one embodiment, the second layer 106 has a second thickness 110, for example, between about 3 mils and about 15 mils, between about 5 mils and about 15 mils, or about 8 mils.

The coating formed by the first layer 104 is applied to the metallic surface 102 of the article 100 by any suitable process. In one embodiment, the first layer 104 is applied proximal to the metallic surface 102 and/or on the metallic surface 102, then the second layer 106 is applied distal from the metallic surface 102 and/or exposed to the environment. The first layer 104 is applied by a process that does not result in penetration into the metallic surface 102 of particles forming the first layer 104. For example, in one embodiment, the first layer 104 is applied by cold spray, thermal spray (such as, HVOF), physical vapor deposition or plating, or combinations thereof. The second layer 106 is applied by a process that permits adherence to the first layer 104 or any further intermediate layers (not shown). For example, in one embodiment, the second layer 106 is applied by cold spray, physical vapor deposition, plating, or thermal spray (such as, high velocity oxygen fuel thermal spray), or combinations thereof.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A coated article, comprising:
a metallic surface;
a first layer positioned proximal to the metallic surface, the first layer having a first ductility; and
a second layer positioned distal from the metallic surface, the second layer having a second ductility;
wherein the first ductility is at least about 20% greater than the second ductility.

2. The coated article of claim 1, wherein the second layer has less fatigue resistance than the metallic substrate.

3. The coated article of claim 1, wherein the first layer prevents crack propagation from the second layer into the metallic article.

4. The coated article of claim 1, wherein the first layer has a higher fracture stress than the second layer.

5. The coated article of claim 1, wherein the first layer reduces stress in the second layer and extends a strain range of the second layer.

6. The coated article of claim 1, wherein the positioning of the first layer and the second layer enhances wear performance of the metallic surface.

7. The coated article of claim 1, wherein the first layer has a first thickness between about 3 mils and about 15 mils.

8. The coated article of claim 1, wherein the first layer is an aluminum-based alloy.

9. The coated article of claim 1, wherein the second layer includes one or more of tungsten carbide, boron carbide, chrome carbide, and cobalt.

10. The coated article of claim 1, wherein the coated article is a compressor component or a turbine component.

11. The coated article of claim 1, wherein the coated article includes a substrate having a compositional range, the compositional range being, by weight, between about 14.0% and about 16.0% Cr, between about 6.0% and about 7.0% Ni, between about 1.25% and about 1.75% Cu, between about 0.5% and about 1.0% Mo, between about 0.025% and about 0.050% C, between about 0.20% and about 0.75% Nb, a maximum of about 1.0% Mn, a maximum of about 1.0% Si, a maximum of about 0.10% V, a maximum of about 0.10% Sn, a maximum of about 0.030% N, a maximum of about 0.025% P, a maximum of about 0.05% S, a maximum of about 0.005% Al, a maximum of about 0.005% Ag, a maximum of about 0.005% Pb, a balance of Fe, and inevitable impurities.

12. The coated article of claim 1, wherein the metallic surface has a compositional range, the compositional range being, by weight, up to about 0.08% C, up to about 0.35% Mn, up to about 0.35% Si, up to about 0.015% P, up to about 0.015% S, between about 50% and about 55% Ni, between about 17% and about 21% Cr, up to about 1.0% Co, between about 0.35% and about 0.80% Al, between about 2.8% and about 3.3% Mo, between about 0.65% and about 1.2% Ti, between about 0.001% and about 0.006%, up to about 0.15% Cu, between about 4.75% and about 5.5% Nb with Ta, a balance Fe, and inevitable impurities.

13. The coated article of claim 1, wherein the metallic surface is a wear surface.

14. The coated article of claim 1, wherein the metallic surface is one or both of a rotating surface and a sliding surface.

15. The coated article of claim 1, wherein the metallic surface is a compressor blade tip.

16. The coated article of claim 1, wherein the first layer is an interlayer positioned on the metallic surface.

17. The coated article of claim 1, wherein the second layer is positioned on the first layer.

18. A coated article, comprising:
a metallic surface;
an interlayer positioned on the metallic surface, the interlayer having a first ductility; and
an outer layer positioned on the interlayer, the outer layer having a second ductility;
wherein the first ductility is at least 20% greater than the second ductility.

19. A coating application process, comprising:
providing an article, the article comprising a metallic surface;
applying a first layer proximal to the metallic surface, the first layer having a first ductility; and
applying a second layer distal from the metallic surface, the second layer having a second ductility;
wherein the first ductility is at least 20% greater than the second ductility.

20. The coating application process of claim 19, further comprising selecting a first material for the first layer and a second material the second layer based upon the relative ductility.
